(19) United States
(12) Patent Application Publication
(10) Pub. No.: US 2026/0279232 A1
(43) Pub. Date: Sep. 17, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Sohee LIM, Suwon-si (KR); Eunseok SONG, Suwon-si (KR); Yongkook KIM, Suwon-si (KR); Hyeontaek LIM, Suwon-si (KR); Boseok MOON, Suwon-si (KR)

(73) Assignee: SAMSUNG ELECTRONICS CO., LTD., Suwon-si (KR)

(21) Appl. No.: 19/573,709

(22) Filed: Mar. 20, 2026

Related U.S. Application Data
(63) Continuation of application No. PCT/KR2026/002847, filed on Feb. 19, 2026.

(30) Foreign Application Priority Data
Mar. 17, 2025 (KR) 10-2025-0034048
Jul. 14, 2025 (KR) 10-2025-0094715

(51) Int. Cl. G09G 3/00; G06F 3/042; G06V 10/25; G06V 20/50

(52) U.S. Cl. CPC G09G 3/001; G06F 3/042; G06V 10/25; G06V 20/50; G09G 2354/00

(57) ABSTRACT

An electronic apparatus according to the disclosure includes a camera, a projector for projecting an image onto a projection area, memory, and at least one processor configured to obtain an image of the projection area captured by the camera, identify an external electronic apparatus and at least one object within the projection area based on the image, identify, within the projection area, a first area including the external electronic apparatus and a second area including the at least one object based on the obtained image, identity a third area of the projection area excluding the first area and the second area, identify a fourth area, in the third area, in which a user input is detectable based on light output from the external electronic apparatus, and project a projection image onto at least a partial area of the fourth area.

### CROSS-REFERENCE TO RELATED APPLICATIONS

This application is a continuation application of International Application No. PCT/KR2026/002847, filed on February 19, 2026, which is based on and claims priority to Korean Patent Application No. 10-2025-0034048, filed on March 17, 2025, in the Korean Intellectual Property Office, and Korean Patent Application No. 10-2025-0094715, filed on July 14, 2025, in the Korean Intellectual Property Office, the disclosures of which are incorporated by reference herein in their entireties.

### BACKGROUND

### 1. Field

The disclosure relates to an electronic apparatus and a controlling method thereof, and more particularly, to an electronic apparatus that determines an area for projecting an image and provides an image, and a controlling method thereof.

### 2. Description of Related Art

An electronic apparatus may project an image onto a projection area by using a projector. A projection area may indicate a space which becomes a target of projection of an optical signal by an electronic apparatus using a projector. An electronic apparatus may identify a user input for an image projected onto a projection area, and provide a function corresponding thereto.

However, in the related art, the projection area is a fixed area that does not take into consideration any objects or obstacles present within the projection area.

### SUMMARY

An electronic apparatus according to the disclosure may include a camera, a projector that projects an image onto a projection area, memory storing instructions, and at least one processor including processing circuitry, wherein the instructions, when executed by the at least one processor individually or collectively, may cause the electronic apparatus to obtain an image of the projection area captured by the camera, identify an external electronic apparatus and at least one object within the projection area based on the image, identify, within the projection area, a first area including the external electronic apparatus and a second area including the at least one object based on the obtained image, identity a third area of the projection area excluding the first area and the second area, identify a fourth area, in the third area, in which a user input is detectable based on light output from the external electronic apparatus, and project, via the projector, a projection image onto at least a partial area of the fourth area.

A controlling method of an electronic apparatus according to the disclosure may include obtaining an image of the projection area captured by a camera, and identifying an external electronic apparatus and at least one object within the projection area based on the image, identifying, within the projection area, a first area including the external electronic apparatus and a second area including the at least one object based on the image, identifying a third area of the projection area excluding the first area and the second area, identifying a fourth area, in the third area, in which a user input is detectable based on light output from the external electronic apparatus, and projecting, via the projector, a projection image onto at least a partial area of the fourth area.

In a non-transitory computer-readable recording medium storing instructions which, when executed by at least one processor of an electronic apparatus, cause the electronic apparatus perform operations according to the disclosure, the operations may include obtaining an image of the projection area captured by a camera, and identifying an external electronic apparatus and at least one object within the projection area based on the image, identifying, within the projection area, a first area including the external electronic apparatus and a second area including the at least one object based on the image, identifying a third area of the projection area excluding the first area and the second area, identifying a fourth area, in the third area, in which a user input is detectable based on light output from the external electronic apparatus, and projecting, via the projector, a projection image onto at least a partial area of the fourth area.

### BRIEF DESCRIPTION OF THE DRAWINGS

These and/or other aspects, features, and advantages of certain embodiments of the disclosure will be more apparent from the following description taken in conjunction with the accompanying drawings, in which:

FIG. 1 is a diagram for illustrating a schematic operation of the disclosure according to an embodiment;

FIG. 2 is a block diagram for illustrating a configuration of an electronic apparatus according to an embodiment;

FIG. 3 is a block diagram for illustrating a configuration of an external electronic apparatus according to an embodiment;

FIG. 4 is a flow chart for illustrating an operation of an electronic apparatus of identifying an area for projecting an image according to an embodiment;

FIG. 5 is a diagram for illustrating an example of a projection area captured by an electronic apparatus using a camera according to an embodiment;

FIG. 6 is a diagram for illustrating an operation of an electronic apparatus of identifying a third area according to an embodiment;

FIG. 7 is a diagram for illustrating an example of an operation of an electronic apparatus of detecting whether there is a user input based on light output from an external electronic apparatus according to an embodiment;

FIG. 8 is a diagram for illustrating an example of an operation of an electronic apparatus of dividing a third area into a plurality of areas according to an embodiment;

FIG. 9 is a diagram for illustrating an example of an operation of an electronic apparatus of identifying an area not reachable by light among a plurality of areas according to an embodiment;

FIG. 10 is a diagram for illustrating an example of an operation of an electronic apparatus of identifying an area reachable by light among a plurality of areas according to an embodiment;

FIG. 11 is a diagram for illustrating an example of an operation of an electronic apparatus of identifying a fourth area according to an embodiment;

FIG. 12 is a diagram illustrating an example of a candidate area according to an embodiment;

FIG. 13 is a diagram illustrating an example of a candidate area according to an embodiment;

FIG. 14 are diagrams illustrating an example of a candidate area according to an embodiment; and

FIG. 15 is a block diagram for illustrating a detailed configuration of an electronic apparatus according to an embodiment.

### DETAILED DESCRIPTION

Hereinafter, the disclosure will be described in detail with reference to the accompanying drawings.

An electronic apparatus according to various embodiments disclosed herein may be devices in various forms. An electronic apparatus may include, for example, a portable communication device (e.g.: a smartphone), a computer device, a portable multimedia device, a portable medical device, a camera, a wearable device, or a home appliance. Meanwhile, an electronic apparatus according to the embodiments of the disclosure is not limited to the aforementioned devices.

Various embodiments of the disclosure and the terms used in the embodiments are not for limiting the technological characteristics described in the disclosure to specific embodiments, but they should be interpreted to include various modifications, equivalents, or alternatives of the embodiments. Also, with respect to the detailed description of the drawings, similar or related components may be designated by similar reference numerals. In addition, a singular form of a noun corresponding to an item may include one of the item or a plurality of the items, unless instructed obviously differently in the related context. Further, in the disclosure, each of the phrases “A or B,” “at least one of A and B,” “at least one of A or B,” “A, B, or C,” “at least one of A, B, and C,” and “at least one of A, B, or C” and the like may include any one of the items listed together with the phrase among the phrases, or all possible combinations of the listed items. In addition, terms such as “first,” “second,” and the like may be used just to distinguish a component from another component, and are not intended to limit a component in another aspect (e.g.: importance or order). Also, in case it is mentioned that one (e.g.: the first) element is “coupled” or “connected” with another (e.g.: the second) element together with the terms “operatively” or “communicatively,” or without such terms, it means that the one element may be connected with the another element directly (e.g.: via wire), wirelessly, or through a third element.

Further, in the overall specification, singular expressions include plural expressions, unless defined obviously differently in the context. Also, in the overall specification, the description that a part “includes” an element means that another element may be further included, but not that another element is excluded, unless there is a particular opposing description.

Also, in the disclosure, “obtaining” may include an operation of obtaining specific data. Here, “obtaining” may include an operation of receiving and obtaining data, an operation of identifying and obtaining data, an operation of deriving and obtaining data, an operation of determining and obtaining data, an operation of analyzing and obtaining data, an operation of finding and obtaining data, an operation of searching and obtaining data, an operation of recognizing and obtaining data, an operation of detecting and obtaining data, an operation of distinguishing and obtaining data, an operation of dividing and obtaining data, and an operation of separating and obtaining data.

In addition, the term “module” used in the various embodiments of the disclosure may include a unit implemented as hardware, software, or firmware, and may be interchangeably used with, for example, terms such as a logic, a logical block, a component, or a circuit. Also, a module may be a component constituted as an integrated body or a minimum unit or a part of the component performing one or more functions. For example, according to an embodiment, a module may be implemented in the form of an application-specific integrated circuit (ASIC).

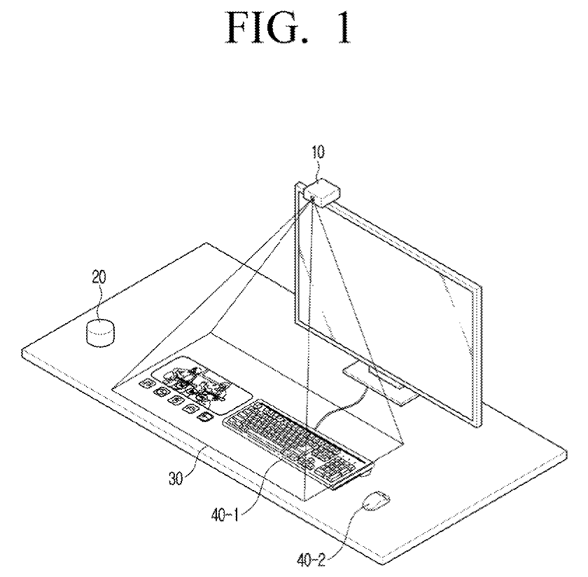

FIG. 1 is a diagram for illustrating a schematic operation of the disclosure according to an embodiment.

Referring to FIG. 1, according to an embodiment, an electronic apparatus 10 may project an image onto a projection area 30 by using a projector.

The projection area 30 may indicate a space which becomes a target of projection of an optical signal by the electronic apparatus 10 using the projector. For example, the projection area 30 may include some areas of a space located in a projection direction of the projector such as a desk, a wall, and a screen, etc., but is not limited thereto. The projection area 30 may be replaced by expressions such as “a projection region,” “a display area,” “a screen display area,” etc., but is not limited to the aforementioned examples.

According to an embodiment, the electronic apparatus 10 may project an image on at least a partial area of the projection area 30. An image according to an embodiment of the disclosure may include visual information in various forms. For example, an image may include user interface (UI) elements.

In the disclosure, “a UI element” may include a graphic interface element that constitutes a user interface used in an interaction between a user and an electronic apparatus. For example, a UI element may be referred to as an item, an object, a UI object, etc., and may include an icon, a button, an image, etc. that can receive a user input. Meanwhile, a UI element may include not only an input element, but also a visual interface such as an information display widget, an image provision platform, etc.

According to an embodiment, the electronic apparatus 10 may obtain a user input for an image projected on the projection area 30. A user input may include a touch input for a UI element included in an image projected onto the projection area 30, but is not limited thereto. The electronic apparatus 10 may be constituted such that, in case an input for a UI element was received from the user, perform an operation or an instruction associated with the UI element. According to an embodiment, the electronic apparatus 10 may identify a touch input of the user based on an image and distance information. Here, the image may include an image obtained through a camera of the electronic apparatus 10. The camera may be arranged to capture a direction in which the projection area 30 is located. The distance information may include a distance between an external electronic apparatus 20 and an ambient object. The external electronic apparatus 20 may include at least one distance detection sensor (e.g. an IR sensor), and include an electronic apparatus that detects a distance with an adjacent object (also referred to as external object). The external electronic apparatus 20 may detect a distance between the external electronic apparatus 20 and an adjacent object at a predetermined height (e.g.: 1cm) by using the at least one distance detection sensor. The external electronic apparatus 20 may transmit distance information to the electronic apparatus 10 through a communication circuit.

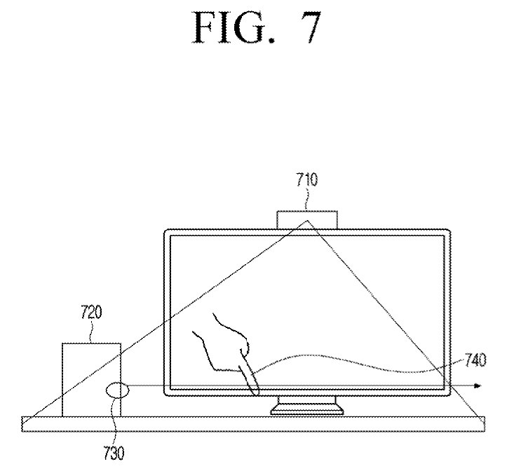

According to an embodiment, the electronic apparatus 10 may detect a location of an object (e.g.: a hand, a finger, a touch pen, etc.) for identifying a user input from an image. The electronic apparatus 10 may identify a UI element corresponding to the detected location of the object among a plurality of UI elements. In case it was identified that the distance between the object and the projection area 30 is smaller than or equal to a predetermined distance, the electronic apparatus 10 may obtain a touch input of the user for the UI element corresponding to the location of the object. Here, the electronic apparatus 10 may identify whether the distance between the object and the projection area 30 is smaller than or equal to the predetermined distance (e.g.: 1cm) based on the distance information received from the external electronic apparatus 20. Hereinafter, detailed explanation regarding an operation of the electronic apparatus 10 of identifying an input of the user will be described in FIG. 7.

Meanwhile, objects 40-1, 40-2 may be located in the projection area 30. The objects 40-1, 40-2 may include, for example, objects such as a keyboard, a mouse, a cup, or a calendar, etc., but are not limited thereto. A conventional electronic apparatus including a projector having a fixed projection area has a problem that it cannot dynamically adjust the projection area 30 even if an object exists in the projection area 30. Meanwhile, the electronic apparatus 10 according to the disclosure dynamically identifies, analyzes, and adjusts an area onto which UI elements are projected in case the objects 40-1, 40-2 are located in the projection area 30, and accordingly, the user can interact with the electronic apparatus 10 more intuitively and effectively within a work space. Hereinafter, a method of identifying an area onto which UI elements are projected will be explained in the drawings.

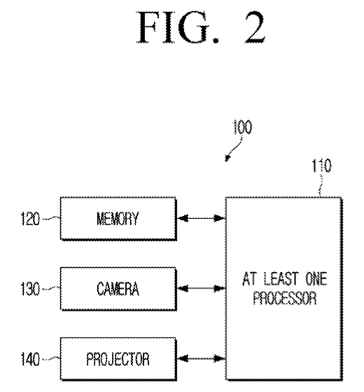

FIG. 2 is a block diagram for illustrating a configuration of an electronic apparatus according to an embodiment.

The electronic apparatus 10 in FIG. 1 may correspond to the electronic apparatus 100 in FIG. 2. Also, the electronic apparatus 100 in FIG. 2 may correspond to the electronic apparatus 10 in FIG. 1. Referring to FIG. 2, the electronic apparatus 100 may include at least one processor 110 (referred to as the processor 110 hereinafter), at least one memory 120 (referred to as the memory 120 hereinafter), at least one camera 130 (referred to as the camera 130 hereinafter), and at least one projector 140 (referred to as the projector 140 hereinafter).

The processor 110 may control the overall operations of the electronic apparatus 100. For example, the processor 110 may be operatively connected with the memory 120, the camera 130, and the projector 140, and control the operations of the electronic apparatus 100. Also, the processor 110 may control the operations of the electronic apparatus 100 according to the disclosure by executing at least one instruction stored in the memory 120. The processor 110 may consist of one or a plurality of processors.

The processor 110 may be implemented as at least one integrated circuit (or circuitry) (IC) chip, and execute various types of data processing. The processor 110 may include at least one electric circuit, and may dispersively process instructions (or programs, data, others, etc.) stored in the memory 120 individually or collectively. The processor 110 may include a processor assembly including at least one processing circuit. The processor 110 may include any operative processing circuit for controlling the performance and operations of one or more components (e.g.: the memory 120, the communication circuit) of the electronic apparatus 100. For example, the processor 110 (e.g.: an application processor (AP)) may be implemented as a system on chip (SoC) (e.g., one chip or a chip set). For example, the processor 110 may be implemented as a plurality of cores (or at least one core circuit), a plurality of chips, or a plurality of chip sets. For example, the processor 110 may include one or more processing circuits. For example, the processor 110 may include one or more processing circuits that are constituted to individually and/or collectively perform several functions in the disclosure. As an unlimited example, at least a part of the processor 110 may be included in a first chip of the electronic apparatus 100, and at least another part of the processor 110 may be included in a second chip of the electronic apparatus 100 different from the first chip of the electronic apparatus 100.

For example, the processor 110 may include a central processing unit (CPU), a graphics processing unit (GPU), a neural processing unit (NPU), an image signal processor (ISP), a display controller, a memory controller, a storage controller, a communication processor (CP), and/or a sensor interface. These components of the processor 110 are merely exemplary ones. For example, the processor 110 may further include other components. For example, some components of the processor 110 may be omitted from the processor 110. For example, some components of the processor 110 may be included as separate components of the electronic apparatus 100 outside the processor 110. For example, some components of the processor 110 (e.g.: the memory controller) may be included in the other components (e.g.: at least a portion of the memory 120, the interface (e.g.: can be used to connect to the at least one component of the electronic apparatus 100), the display).

The processor 110 may cause the other components of the electronic apparatus 100 to perform various operations by executing the instructions stored in the memory 120. The CPU (or a central processing circuit) may be constituted to control the components of the processor 110 based on execution of instructions stored in the memory 120 (e.g.: volatile memory and/or non-volatile memory). The GPU (or a graphics processing circuit) may be constituted to execute parallel operations (e.g.: rendering). The NPU (or a neural processing circuit, or an artificial intelligence (AI) chip) may be constituted to execute operations for an artificial intelligence model (e.g.: convolution computations). The ISP (or an image signal processing circuit) may be constituted to process a raw image obtained through the image sensor in a format appropriate for the components inside the electronic apparatus 100 or the components of the processor 110. The memory controller (or a memory control circuit) may be constituted to control reading of data from the volatile memory and recording of the data in the volatile memory. The storage controller (or a storage control circuit) may be constituted to control reading of data from the non-volatile memory and recording of the data in the non-volatile memory. The CP (or a communication processing circuit) may be constituted to process data obtained from the components of the processor 110 in a format appropriate for being transmitted to another electronic apparatus through the communication circuit, or process data obtained from another electronic apparatus through the communication circuit in a format appropriate for processing the components of the processor 110. For example, the communication circuit may include one or more communication circuits. The sensor interface (or a sensing data processing circuit, a sensor hub) may be constituted to process data regarding the state of the electronic apparatus 100 and/or the state of the surroundings of the electronic apparatus 100 obtained through the sensor in a format appropriate for the components of the processor 110.

For example, the processor 110 may perform the method according to the embodiments of the disclosure by executing the at least one instruction stored in the memory 120.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 110 may be implemented as a single core processor including one core, or may be implemented as one or more multicore processors including a plurality of cores (e.g., multicores of the same kind or multicores of different kinds). In case the processor 110 is implemented as multicore processors, each of the plurality of cores included in the multicore processors may include internal memory of the processor such as cache memory, on-chip memory, etc., and common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor may mean a system on chip (SoC) wherein at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto. The memory 120 may be implemented as internal memory such as ROM (e.g., electrically erasable programmable read-only memory (EEPROM)), RAM, etc., included in the at least one processor 110, or implemented as separate memory from the at least one processor 110. In this case, the memory 120 may be implemented in the form of memory embedded in the electronic apparatus 100, or implemented in the form of memory that can be attached to or detached from the electronic apparatus 100 according to the use of stored data. For example, in the case of data for driving the electronic apparatus 100, the data may be stored in memory embedded in the electronic apparatus 100, and in the case of data for an extended function of the electronic apparatus 100, the data may be stored in memory that can be attached to or detached from the electronic apparatus 100.

In the case of memory embedded in the electronic apparatus 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). In the case of memory that can be attached to or detached from the electronic apparatus 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), external memory that can be connected to a USB port (e.g., a USB memory), etc.

The memory 120 may include one or more storage media (or one or more store devices). For example, the memory 120 may include a memory assembly including one or more storage media. For example, the one or more storage media may include permanent memory (e.g., non-volatile memory) such as a hard drive, flash memory, and read-only memory (ROM), semi-permanent memory (e.g., volatile memory) such as random access memory (RAM), a storage (or a storage assembly) of any other suitable type, or any combination thereof. The memory 120 may include cache memory which is memory of one or more different types that is used for temporarily storing data for the functions or the features of the electronic apparatus 100. As an unlimited example, the cache memory may be included inside the processor 110. The memory 120 may be fixedly embedded in the electronic apparatus 100, or incorporated into one or more suitable types of components (e.g.: a subscriber identity module (SIM) card and/or a secure digital (SD) card) that can be repeatedly inserted into the electronic apparatus 100 and can be removed from the electronic apparatus 100.

For example, the memory 120 may store one or more software applications such as an operating system (or a system) software application, a firmware software application, a driver software application, a plug-in (e.g., an add-in, an add-on, and/or an applet) software application, and/or any other suitable software application. For example, the one or more software applications may include instructions that can be executed by the processor 110. For example, the memory 120 may store instructions that can be called by an application programming interface (API). For example, the memory 120 may store instructions within a library.

In the disclosure, the term memory 120 may be used as a meaning including a storage part, ROM (not shown) and RAM (not shown) inside the at least one processor 111, or a memory card (not shown) (e.g., a micro SD card, a memory stick) installed on the electronic apparatus 100.

The camera 130 may obtain an image corresponding to a subject by converting light emitted or reflected from the subject and transmitted into an electric signal by using an image sensor. According to an embodiment, the image sensor may include, for example, an RGB sensor, a black and white (BW) sensor, an IR sensor, or an image sensor selected from image sensors having different attributes such as a UV sensor, a plurality of image sensors having the same attributes, or a plurality of image sensors having different attributes.

The projector 140 is a component that projects an image to the outside. The projector 140 according to the various embodiments of the disclosure may be implemented by various projection methods (e.g., a cathode-ray tube (CRT) method, a liquid crystal display (LCD) method, a digital light processing (DLP) method, a laser method, etc.). As an example, the CRT method has basically the same principle as a CRT monitor. In the CRT method, an image is enlarged to a lens in front of a cathode-ray tube (CRT), and the image is displayed on a screen. According to the number of cathode-ray tubes, the CRT method is divided into a one-tube method and a three-tube method, and in the case of the three-tube method, the method may be implemented while cathode-ray tubes of red, green, and blue colors are separated from one another.

As another example, the LCD method is a method of displaying an image by making light output from a light source pass through a liquid crystal display. The LCD method is divided into a single-plate method and a three-plate method, and in the case of the three-plate method, light output from a light source may be divided into red, green, and blue colors in a dichroic mirror (a mirror that reflects only lights of specific colors, and makes the rest pass through), and pass through a liquid crystal display, and then the lights may be gathered in one place.

As still another example, the DLP method is a method of displaying an image by using a digital micromirror device (DMD) chip. A projection part by the DLP method may include a light source, a color wheel, a DMD chip, a projection lens, etc. Light output from the light source may show a color as it passes through the rotating color wheel. The light that passed through the color wheel is input into the DMD chip. The DMD chip includes numerous micromirrors, and reflects the light input into the DMD chip. The projection lens may perform a role of enlarging the light reflected from the DMD chip to an image size.

As still another example, the laser method includes a diode pumped solid state (DPSS) laser and a galvanometer. As lasers outputting various colors, lasers wherein three DPSS lasers are installed for each of R, G, and B colors, and then their optical axes are overlapped by using a special mirror are used. The galvanometer includes a mirror and a motor of a high output, and moves the mirror at a fast speed. For example, the galvanometer may rotate the mirror at 40 KHz/sec at the maximum. The galvanometer is mounted according to a scanning direction, and in general, a projector performs plane scanning, and thus the galvanometer may also be arranged while being divided into x and y axes.

The projector 140 may include various types of light sources. For example, the projector 140 may include at least one light source among a lamp, LEDs, and laser.

The projector 140 may output an image in a screen ratio of 4:3, a screen ratio of 5:4, and a wide screen ratio of 16:9 according to the use of the electronic apparatus 100 or the user’s setting, etc., and output an image in various resolutions such as WVGA (854*480), SVGA (800*600), XGA (1024*768), WXGA (1280*720), WXGA (1280*800), SXGA (1280*1024), UXGA (1600*1200), Full HD (1920*1080), etc. according to screen ratios.

The projector 140 may perform various functions for adjusting an output image by control by the at least one processor 110. For example, the projector 140 may perform functions such as zoom, keystone, quick corner (four corner) keystone, lens shift, etc.

Specifically, the projector 140 may enlarge or reduce an image according to a distance from a screen (a projection distance). In other words, a zoom function may be performed according to a distance from a screen. Here, the zoom function may include a hardware method of adjusting the size of a screen by moving a lens and a software method of adjusting the size of a screen by a crop, etc. When the zoom function is performed, adjustment of a focus of an image is needed. For example, methods of adjusting a focus include a manual focus method, an electric method, etc. The manual focus method means a method of adjusting a focus manually, and the electric method means a method wherein, when the zoom function is performed, the projector automatically adjusts a focus by using a built-in motor. When performing the zoom function, the projector 140 may provide a digital zoom function through software, and also provide an optical zoom function of performing a zoom function by moving the lens.

The projector 140 may perform a keystone correction function. A screen may be distorted in an upper direction or a lower direction if the height is not matched in front surface projection. The keystone correction function means a function of correcting a distorted screen. For example, if a distortion occurs in a left-right direction of a screen, the screen may be corrected by using horizontal keystone, and if a distortion occurs in an up-down direction, the screen may be corrected by using vertical keystone. The quick corner (four corner) keystone correction function is a function of correcting a screen in case the central area of the screen is normal, but the corner areas are out of balance. The lens shift function is a function of moving a screen as it is in case the screen is beyond the range of the screen.

The projector 140 may provide the zoom/keystone/focus functions by automatically analyzing the ambient environment and the projection environment without a user input. Specifically, the projector 140 may automatically provide the zoom/keystone/focus functions based on the distance between the electronic apparatus 100 and the screen detected through the sensor (a depth camera, a distance sensor, an infrared sensor, an illumination sensor, etc.), information on the space wherein the electronic apparatus 100 is currently located, information on the ambient light amount, etc.

The projector 140 may provide an illumination function by using a light source. In particular, the projector 140 may provide an illumination function by outputting a light source by using LEDs. According to various embodiments, the projector 140 may include one LED. According to another embodiment, the electronic apparatus 100 may include a plurality of LEDs. The projector 140 may output a light source by using a surface emitting LED depending on implementation examples. A surface emitting LED may mean an LED having a structure wherein an optical sheet is arranged on the upper side of the LED such that a light source is evenly dispersed and output. Specifically, if a light source is output through an LED, the light source may be evenly dispersed through an optical sheet, and the light source dispersed through the optical sheet may be incident on a display panel.

The projector 140 may provide a dimming function for adjusting the strength of a light source to the user. Specifically, if a user input for adjusting the strength of a light source is received from the user through the manipulation interface 140 (e.g., a touch display button or a dial), the projector 140 may control the LEDs to output the strength of the light source corresponding to the received user input.

The projector 140 may provide the dimming function based on a content analyzed by the at least one processor 110 without a user input. Specifically, the projector 140 may control the LEDs to output the intensity of a light source based on information on the currently provided content (e.g., the content type, the content brightness, etc.).

The projector 140 may control the color temperature by control by the at least one processor 110. The at least one processor 110 may control the color temperature based on a content. Specifically, if it is identified that a content is to be output, the at least one processor 110 may obtain the color information for each frame of the content of which output has been determined. Then, the at least one processor 110 may control the color temperature based on the obtained color information for each frame. The at least one processor 110 may obtain at least one main color of the frames based on the color information for each frame. Then, the at least one processor 110 may adjust the color temperature based on the obtained at least one main color. For example, the color temperature that can be adjusted by the at least one processor 110 may be divided into a warm type or a cold type. It is assumed that a frame to be output (referred to as an output frame hereinafter) includes a scene wherein fire broke out. The at least one processor 110 may identify (or obtain) that the main color is a red color based on the color information included in the current output frame. Then, the at least one processor 110 may identify a color temperature corresponding to the identified main color (red). The color temperature corresponding to the red color may be the warm type. The at least one processor 110 may use an artificial intelligence model for obtaining the color information or the main color of a frame. According to various embodiments, the artificial intelligence model may be stored in the electronic apparatus 100 (e.g., the memory 120). According to another embodiment, the artificial intelligence model may be stored in an external server that can communicate with the electronic apparatus 100.

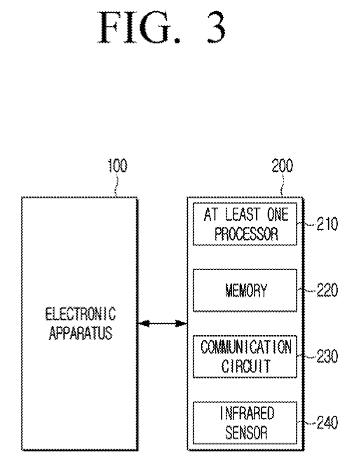

FIG. 3 is a block diagram for illustrating a configuration of an external electronic apparatus according to an embodiment.

The external electronic apparatus 20 in FIG. 1 may correspond to the external electronic apparatus 200 in FIG. 3. Also, the external electronic apparatus 200 in FIG. 3 may correspond to the external electronic apparatus 20 in FIG. 1. Referring to FIG. 3, the external electronic apparatus 200 may include at least one processor 210 (referred to as the processor 210 hereinafter), at least one memory 220 (referred to as the memory 220 hereinafter), a communication circuit 230, and at least one infrared sensor 240 (referred to as the infrared sensor 240 hereinafter).

The processor 210 controls the overall operations of the external electronic apparatus 200. Specifically, the processor 210 may be connected with each component of the external electronic apparatus 200, and control the overall operations of the external electronic apparatus 200. For example, the processor 210 may be electrically connected with the external electronic apparatus 200 and the memory 220, and control the overall operations of the external electronic apparatus 200. The processor 210 may consist of one or a plurality of processors. The processor 210 may control the operations of the external electronic apparatus 200 according to the disclosure by executing the one or more instructions stored in the memory 220.

The processor 210 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The processor 210 may control one or a random combination of the other components of the external electronic apparatus 200, and perform an operation related to communication or data processing. The processor 210 may execute one or more programs or instructions stored in the memory. For example, the processor 210 may perform the method according to an embodiment of the disclosure by executing the one or more instructions stored in the memory.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The processor 210 may be implemented as a single core processor including one core, or it may be implemented as one or more multicore processors including a plurality of cores (e.g., multicores of the same kind or multicores of different kinds). In case the processor 210 is implemented as multicore processors, each of the plurality of cores included in the multicore processors may include internal memory of the processor such as cache memory, on-chip memory, etc., and a common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor 210 may mean a system on chip (SoC) wherein at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto.

The memory 220 is a component for storing various programs, instructions, data, etc. used in operations of the external electronic apparatus 200. The memory 220 may be implemented as at least one of various memories such as dynamic RAM (DRAM), static RAM (SRAM), synchronous dynamic RAM (SDRAM), one time programmable ROM (OTPROM), programmable ROM (PROM), erasable and programmable ROM (EPROM), electrically erasable and programmable ROM (EEPROM), mask ROM, flash ROM, flash memory, a hard drive, or a solid state drive (SSD), etc.

The communication circuit 230 may transmit and receive various types of signals and data with an external device through various types of wired/wireless communication methods such as Bluetooth, Wi-Fi based on AP (Wi-Fi, a Wireless LAN Network), Zigbee, a wired/wireless Local Area Network (LAN), a Wide Area Network (WAN), Ethernet, IEEE 1394, a High-Definition Multimedia Interface (HDMI), a Universal Serial Bus (USB), a Mobile High-Definition Link (MHL), Audio Engineering Society/European Broadcasting Union (AES/EBU), Optical, Coaxial, etc.

The infrared sensor 240 may detect a distance between the external electronic apparatus 200 and an ambient object. The infrared sensor 240 may include an infrared projection part and an infrared detection part. The infrared projection part may be controlled by the processor 210, and may be constituted to output light (e.g.: an infrared signal). The infrared projection part may output an infrared signal having a specific pattern. For example, the infrared projection part may output an infrared signal toward a predetermined angle range (e.g.: 90 degrees). For example, the infrared projection part may output an infrared signal having a predetermined width. The infrared detection part may detect an infrared signal that was output from the infrared projection part and was reflected by an external object.

The external electronic apparatus 200 may include a plurality of infrared sensors 240. For example, the external electronic apparatus 200 may mount an infrared sensor 240 in each of a plurality of directions (e.g.: up, down, left, and right directions) of the external electronic apparatus 200, and make them detect distance information for all directions. In this case, the plurality of infrared sensors 240 may respectively detect a distance with an external object in a predetermined angle (e.g.: 90 degrees) range. Meanwhile, examples regarding directions and measurement ranges of the infrared sensors 240 are obviously not limited to the aforementioned example.

Meanwhile, the external electronic apparatus 200 may include an IMU sensor (not shown). The inertial measurement unit (IMU) sensor may be constituted to measure acceleration corresponding to a rectilinear motion and angular velocity corresponding to a rotation motion for each of an x axis, a y axis, and a z axis.

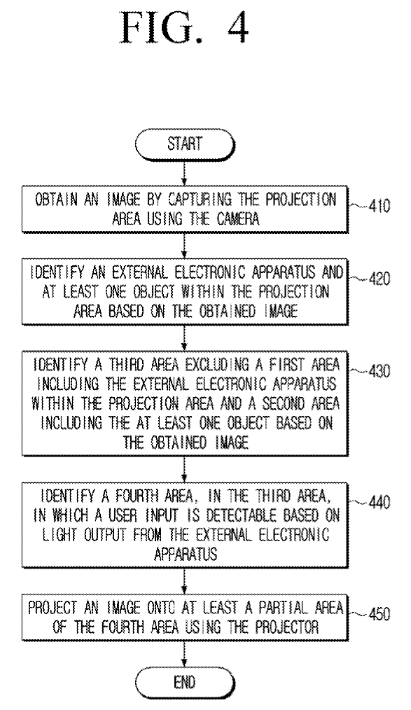

FIG. 4 is a flow chart for illustrating an operation of an electronic apparatus of identifying a projection area according to an embodiment.

The processor 110 of the electronic apparatus 100 may perform at least one operation among the operations in FIG. 4. The instructions stored in the memory 120 of the electronic apparatus 100 may make the electronic apparatus 100 perform the operations in FIG. 4 when they are executed by the processor 110 of the electronic apparatus 100.

In the operation 410, according to an embodiment, the electronic apparatus 100 may obtain an image by capturing a projection area (e.g.: the projection area 30 in FIG. 1) by using the camera 130. The projection area may mean an area which becomes a target of projection of an image through the projector 140. The camera 130 may be arranged to capture the projection area of the projector 140.

In the operation 420, according to an embodiment, the electronic apparatus 100 may identify an external electronic apparatus 200 and at least one object within the projection area based on the obtained image. The at least one object may include an object or a surface that may cause distortion of an image when the electronic apparatus 100 projects an image. The at least one object may include, for example, a keyboard, a mouse, etc., but is not limited thereto.

According to an embodiment, the electronic apparatus 100 may identify the external electronic apparatus 200 and the at least one object from the image by using an artificial intelligence model. For example, the electronic apparatus 100 may identify the types of the external electronic apparatus 200 and the at least one object by inputting the image into the artificial intelligence model.

For the artificial intelligence model, for example, an object detection model that was trained in advance such as a you only look once (YOLO) model, a faster R-CNN model, or a single shot multibox detector (SSD) model, etc. may be used, but the disclosure is not limited thereto. The object detection model may include an artificial intelligence model that was trained to use an image as input data, and use the type of an object included in the image and the area of the object as output data.

The feature that an artificial intelligence model is trained may mean that a basic artificial intelligence model (e.g., an artificial intelligence model including any random parameters) is trained by using a plurality of training data by a learning algorithm, and predefined operation rules or an artificial intelligence model set to perform a desired characteristic (or, a purpose) is thereby made. Such learning may be performed through a separate server and/or a system, but the disclosure is not limited thereto, and the learning may be performed at the electronic apparatus 100. As examples of learning algorithms, there are supervised learning, unsupervised learning, semi-supervised learning, or reinforcement learning, but learning algorithms are not limited to the aforementioned examples. Meanwhile, the artificial intelligence model may be trained to identify the type of the external electronic apparatus 200 and an area including the external electronic apparatus 200 by using an image data set including the external electronic apparatus 200 as training data.

In the operation 430, according to an embodiment, the electronic apparatus 100 may identify a third area excluding a first area and a second area based on the obtained image. In the disclosure, “the first area” may include an area including the external electronic apparatus 200 within the projection area, and “the second area” may include an area including the at least one object within the projection area.

According to an embodiment, the electronic apparatus 100 may identify the first area or the second area by inputting the image into the artificial intelligence model. For the artificial intelligence model, the object recognition model described above in the operation 420 may be used. The artificial intelligence model may be trained to identify a type of an object and an area of the object from an image based on a bounding box. Here, the object may include the external electronic apparatus 200 or the at least one object, and the object area may include the first area or the second area.

The artificial intelligence model that identifies a type of an object and an area of the object based on a bounding box may include an artificial intelligence model that was trained to identify an object area as a quadrangular form, and identify the type of the object included in the object area. Here, the bounding box may indicate a gathering of coordinates of the quadrangular form including the object on the image. The bounding box may be expressed as coordinates in the upper left part and the lower right part of the object area or the central coordinate and the width and the height of the object area. In other words, the first area may include a quadrangular area including the external electronic apparatus 200, and the second area may include a quadrangular area including each of the at least one object. The horizontal side and the vertical side of the quadrangle may be constituted to be in parallel to each of the horizontal side and the vertical side of the projection area.

For example, the electronic apparatus 100 may obtain a central coordinate value (e.g.: a pixel index value) of an object area, a width value of the object area, a height value of the object area, and the type of the object by inputting an image into the artificial intelligence model.

According to an embodiment, the electronic apparatus 100 may identify the first area and the second area based on a central coordinate value of an object area, a width value of the object area, a height value of the object area, and the type of the object. For example, the electronic apparatus 100 may identify an area corresponding to a central coordinate value of an object area, a width value of the object area, and a height value of the object area. In case the type of the object corresponding to the obtained area is the external electronic apparatus 200, the electronic apparatus 100 may identify the obtained area as the first area, and in case the type of the object corresponding to the obtained area is not the external electronic apparatus 200, the electronic apparatus 100 may identify the obtained area as the second area. The electronic apparatus 100 may identify a third area excluding the first area including the external electronic apparatus 200 and the second area including at least one object within the projection image.

In the operation 440, according to an embodiment, the electronic apparatus 100 may identify a fourth area, in the third area, in which a user input is detectable based on light output from the external electronic apparatus 200. In other words, in the disclosure, “the fourth area” may include an area reached by light output from the infrared sensor 240 of the external electronic apparatus 200 (e.g.: infrared rays) in the third area.

According to an embodiment, the electronic apparatus 100 may identify whether there is a user input based on light output from the external electronic apparatus 200. For example, the electronic apparatus 100 may identify whether there is a user input based on distance information from an external object received from the external electronic apparatus 200 through the communication circuit. Here, the distance from the external object may be obtained based on an optical signal output from the external electronic apparatus 200.

For example, the external electronic apparatus 200 may output light in a direction of a predetermined range (e.g.: 360 degrees) at a first height (e.g.: 1cm) by using the infrared sensor 240. The external electronic apparatus 200 may obtain distance information between the external electronic apparatus 200 and the external object by detecting light reflected by the external object by using the infrared sensor 240.

According to an embodiment, the electronic apparatus 100 may identify whether there is a user input based on the distance information received from the external electronic apparatus 200. For example, in case the distance information received from the external electronic apparatus 200 decreased, the electronic apparatus 100 may identify that a user input was generated. As an example, a case wherein the electronic apparatus 100 received distance information measured on a plurality of time points from the external electronic apparatus 200 is assumed. In case it was identified that the distance from the external object is a first distance (e.g.: 30cm) on a first time point (e.g.: 0.025s), a second time point (e.g.: 0.050s), and a third time point (e.g.: 0.075s), and the distance from the external object is a second distance (e.g.: 20cm) shorter than the first distance on a fourth time point (e.g.: 0.100s) and a fifth time point (e.g.: 0.125s), the electronic apparatus 100 may identify that a user input was generated on the fourth time point. Here, the second distance may be a distance shorter than the distance between the external electronic apparatus 200 and the edge of the projection area. Meanwhile, an operation of the electronic apparatus 100 of detecting whether there is a user input based on light output from the external electronic apparatus 200 will be explained in detail in FIG. 7.

According to an embodiment, the electronic apparatus 100 may divide the projection area into a plurality of areas based on extension lines of the edges of the first area and the second area in a quadrangular form. The plurality of areas may consist of at least one quadrangular area.

According to an embodiment, the electronic apparatus 100 may identify that an area reachable by light output from the infrared sensor 240 of the external electronic apparatus 200 among the plurality of areas is the fourth area.

For example, the electronic apparatus 100 may identify whether a line connecting the first area and a vertex of any one area among the plurality of areas overlaps the second area. Specifically, the electronic apparatus 100 may identify lines connecting the central coordinate of the first area and a plurality of vertices of any one area among the plurality of areas. The electronic apparatus 100 may identify whether at least some of the identified lines overlap the second area.

According to an embodiment, in case it was identified that at least some of the lines connecting the first area and vertices of any one area (e.g.: a fifth area) among the plurality of areas overlap the second area, the electronic apparatus 100 may identify that the fifth area is an area not reachable by light output from the infrared sensor 240 of the external electronic apparatus 200.

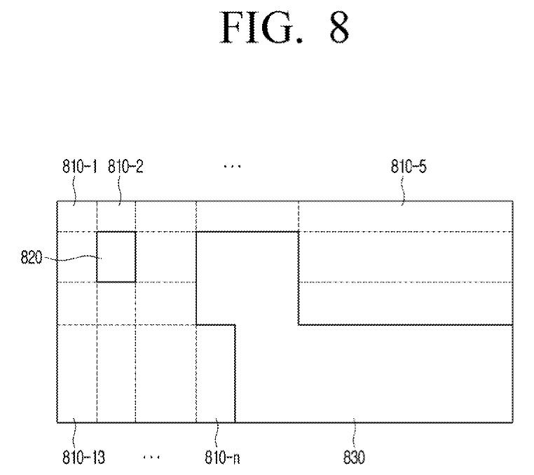

According to an embodiment, in case it was identified that at least some of the lines connecting the first area and vertices of any one area (e.g.: a sixth area) among the plurality of areas do not overlap the second area, the electronic apparatus 100 may identify that the sixth area is an area reachable by light output from the infrared sensor 240 of the external electronic apparatus 200. The electronic apparatus 100 may identify the fourth area consisting of at least one sixth area. Meanwhile, an operation of the electronic apparatus 100 of identifying an area reachable by light among the plurality of areas will be explained in detail in FIG. 8 to FIG. 10.

In the operation 450, according to an embodiment, the electronic apparatus 100 may project an image on at least a partial area of the fourth area by using the projector 140. The image may include user interface elements.

According to an embodiment, the electronic apparatus 100 may identify at least a partial area of the fourth area. According to an embodiment, the electronic apparatus 100 may identify at least one candidate area consisting of at least one area among the plurality of areas constituting the fourth area. For example, the electronic apparatus 100 may merge a relatively small area among the plurality of areas with a relatively big area. For example, the electronic apparatus 100 may obtain at least one candidate area having a size greater than or equal to a predetermined size.

According to an embodiment, the electronic apparatus 100 may identify at least a partial area for projecting an image based on at least one of a size of an area, the number of edges of the area, or the number of vertices of the area. For example, the electronic apparatus 100 may identify a size, the number of edges, and the number of vertices of each of at least one candidate area. The electronic apparatus 100 may calculate a score for each candidate area by applying a corresponding weight to each of a size, the number of edges, and the number of vertices of each candidate area. The electronic apparatus 100 may identify a candidate area having the highest score as the at least partial area for projecting an image.

However, the disclosure is not limited thereto, and the electronic apparatus 100 may identify candidate areas having scores greater than or equal to a predetermined value. Based on receiving a user input for selecting any one candidate area among the candidate areas having scores greater than or equal to the predetermined value, the electronic apparatus 100 may identify the selected candidate area as the at least partial area for projecting an image. Here, the user input may include a touch input, a voice input, etc.

According to an embodiment, the electronic apparatus 100 may identify a candidate area near the first area among the at least one candidate area as at least a partial area for projecting an image. For example, the electronic apparatus 100 may identify a candidate area sharing at least one edge with the first area among the at least one candidate area as the at least partial area for projecting an image. However, the disclosure is not limited thereto, and the electronic apparatus 100 may grant a big weight value to a candidate area near the first area. The electronic apparatus 100 may calculate a score by applying a weight to each of a plurality of elements (e.g.: a distance from the first area, a size of an area, the number of edges, and the number of vertices). The electronic apparatus 100 may identify a candidate area having the biggest score as the at least partial area for projecting an image.

According to an embodiment, the electronic apparatus 100 may project an image on at least a partial area of the fourth area by using the projector.

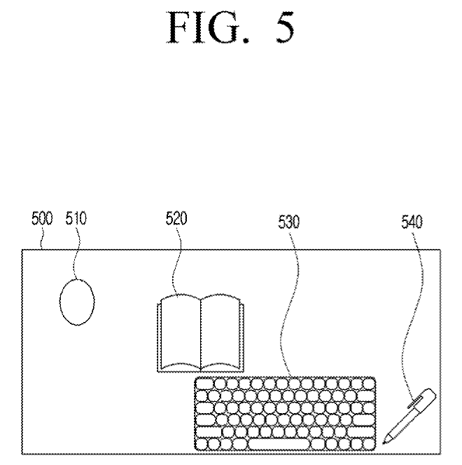

FIG. 5 is a diagram for illustrating an example of a projection area captured by an electronic apparatus using a camera according to an embodiment.

Referring to FIG. 5, according to an embodiment, the electronic apparatus 100 may obtain an image including a projection area 500 by using the camera 130. According to an embodiment, the projection area 500 may indicate a space which becomes a target of projection of an optical signal by using the projector 140 of the electronic apparatus 100.

Meanwhile, an external electronic apparatus 510 or at least one object 520, 530, 540 may be located in a space which becomes a target of projection. The electronic apparatus 100 may identify an area excluding areas including the external electronic apparatus 510 and the at least one object 520, 530, 540 within the projection area 500, and identify at least a partial area for projecting an image by using the projector 140 based on the identified area. In the drawings below, an operation of identifying at least a partial area for projecting an image based on an image including the projection area 500 will be explained in detail.

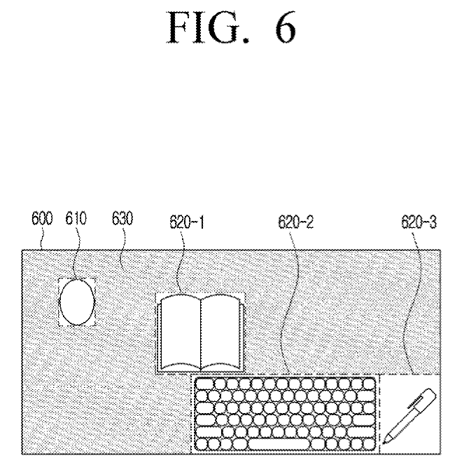

FIG. 6 is a diagram for illustrating an operation of an electronic apparatus of identifying a third area according to an embodiment.

Referring to FIG. 6, according to an embodiment, the electronic apparatus 100 may identify a first area 610, a second area 620-1, 620-2, 620-3, and a third area 630 excluding the first area 610 and the second area 620-1, 620-2, 620-3. The first area 610 may be an area including the external electronic apparatus 200 (e.g., the external electronic apparatus 510 in FIG. 5), and the second area 620-1, 620-2, 620-3 may be an area including at least one object (e.g.: the at least one object 520, 530, 540 in FIG. 5). As described above in FIG. 4, the electronic apparatus 100 may identify the first area or the second area by inputting an image including a projection area 600 into an artificial intelligence model.

For example, the electronic apparatus 100 may identify the first area 610 and the second area 620-1, 620-2, 620-3 by using an artificial intelligence model trained to identify a type of an object and an area of the object from an image based on a bounding box. In this case, the electronic apparatus 100 may identify a bounding box including the external electronic apparatus 200 as the first area 610, and identify a bounding box including the at least one object as the second area 620-1, 620-2, 620-3.

Meanwhile, the electronic apparatus 100 may identify the first area 610 and the second area 620-1, 620-2, 620-3 through an artificial intelligence model trained to identify an object area in pixel units. The model trained to identify an object area in pixel units may include, for example, a model that was trained in advance such as a fully convolutional network (FCN) model, a DeepLab model, a U-Net model, a mask region-based convolutional neural network (Mask R-CNN) model, etc. but is not limited thereto. In this case, the electronic apparatus 100 may identify an area in a quadrangular form including all pixels identified as the external electronic apparatus 200 as the first area 610, and identify an area in a quadrangular form including all pixels identified as the at least one object as the second area 620-1, 620-2, 620-3. As an example, the electronic apparatus 100 may identify each of the biggest row value, the smallest row value, the biggest column value, and the smallest column value among the plurality of pixels identified as the external electronic apparatus 200, and identify an area in a quadrangular form having a horizontal axis and a vertical axis as the first area 610 based on this. As an example, the electronic apparatus 100 may identify each of the biggest row value, the smallest row value, the biggest column value, and the smallest column value among the plurality of pixels identified as the at least one object, and identify an area in a quadrangular form having a horizontal axis and a vertical axis as the second area 620-1, 620-2, 620-3 based on this.

The electronic apparatus 100 may obtain the third area 630 excluding the first area 610 and the second area 620-1, 620-2, 620-3 in the projection area 600. In some embodiments, the third area 630 is a remainder of the projection area excluding the first area 610 and the second area 620-1, 620-2, 620-3.

FIG. 7 is a diagram for illustrating an example of an operation of an electronic apparatus of detecting whether there is a user input based on light output from an external electronic apparatus according to an embodiment.

Referring to FIG. 7, according to an embodiment, the electronic apparatus 710 (e.g.: the electronic apparatus 100 in FIG. 3) may detect whether there is a user input 740 (e.g.: a hand, a finger, a touch pen, etc.) based on light output from the infrared sensor 730 (e.g.: the infrared sensor 240 in FIG. 3) of the external electronic apparatus 720 (e.g.: the external electronic apparatus 200 in FIG. 3).

According to an embodiment, the electronic apparatus 710 may identify a user input 740 based on an image obtained by using the camera 130 and distance information received from the external electronic apparatus 720.

According to an embodiment, the electronic apparatus 710 may identify a point corresponding to the user input 740 based on the image obtained through the camera 130. The electronic apparatus 710 may identify a UI element located on the point corresponding to the user input 740. For example, the electronic apparatus 710 may identify an area including the user’s finger or an area including an input tool (referred to as an input area hereinafter), and an area including a plurality of UI elements projected onto the projection area (referred to as a UI element area hereinafter) based on the image. The electronic apparatus 710 may identify a UI area overlapped with the input area by comparing the input area and the UI element area. The electronic apparatus 710 may identify a UI element corresponding to the UI area overlapped with the input area as the UI element located on the point corresponding to the user input 740. When a user input 740 is identified, the electronic apparatus 710 may perform a function corresponding to the user input 740 for the identified UI element.

Meanwhile, the distance information received from the external electronic apparatus 720 may be used for identifying whether there is a user input 740. According to an embodiment, the external electronic apparatus 720 may include at least one infrared sensor. The external electronic apparatus 720 may output light parallel to a horizontal plane of the first height (e.g.: 1cm) in a direction of a predetermined range through the infrared sensor. As an example, the external electronic apparatus 720 may output an optical signal in a fan shape toward a first range (e.g.: 0 degree or bigger and smaller than 90 degrees) from the first direction (e.g.: the front side) through a first infrared sensor, output an optical signal in a fan shape toward a second range (e.g.: 90 degrees or bigger and smaller than 180 degrees) from the first direction (e.g.: the front side) through a second infrared sensor, output an optical signal in a fan shape toward a third range (e.g.: 180 degrees or bigger and smaller than 270 degrees) from the first direction (e.g.: the front side) through a third infrared sensor, and output an optical signal in a fan shape toward a fourth range (e.g.: 270 degrees or bigger and smaller than 360 degrees) from the first direction (e.g.: the front side) through a fourth infrared sensor. In other words, the external electronic apparatus 720 may output an optical signal in all directions based on the external electronic apparatus 720 by using at least one infrared sensor. Hereinafter, FIG. 7 will be explained based on the first infrared sensor 730 among the at least one infrared sensor.

According to an embodiment, the external electronic apparatus 720 may obtain distance information between an external object and the external electronic apparatus 720. The external electronic apparatus 720 may receive light that was output from the first infrared sensor 730 and was reflected on the external object. The external electronic apparatus 720 may identify the distance from the external object based on the received light. The external electronic apparatus 720 may transmit the distance information from the external object to the electronic apparatus 710.

According to an embodiment, the electronic apparatus 710 may detect whether there is a user input 740 based on the distance information. For example, the electronic apparatus 710 may identify whether the user’s fingertip or an input tool contacted a horizontal plane based on the sensing data. The horizontal plane may mean a virtual plane that is in parallel to the projection area, and is located at a predetermined height based on the projection area. In case it was identified that the distance from the external object decreased by greater than or equal to a predetermined distance based on the sensing data, the electronic apparatus 710 may identify that the user’s hand or an input tool contacted the horizontal plane. In other words, in case the user’s hand or an input tool contacts the horizontal plane, the distance information detected through the infrared sensor 730 decreases, and thus the electronic apparatus 100 may identify that a user input 740 was generated.

FIG. 8 is a diagram for illustrating an example of an operation of an electronic apparatus of dividing a third area into a plurality of areas according to an embodiment.

Referring to FIG. 8, according to an embodiment, the electronic apparatus 100 may divide the third area (e.g.: third area 630 in FIG. 6) into a plurality of areas 810-1, 810-2, …, 810-n. According to an embodiment, the electronic apparatus 100 may divide the projection area into the plurality of areas 810-1, 810-2, …, 810-n based on extension lines of the edges of the first area 820 and the second area 830. For example, the electronic apparatus 100 may extend the edges of the first area 820 and the second area 830 to be respectively in parallel to the edges of the projection area. The electronic apparatus may obtain the plurality of areas 810-1, 810-2, …, 810-n based on the extension lines.

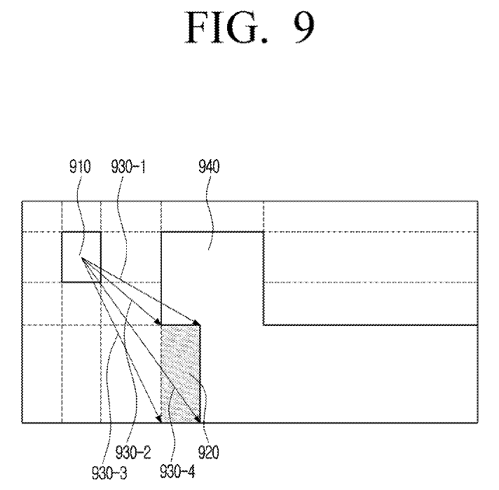

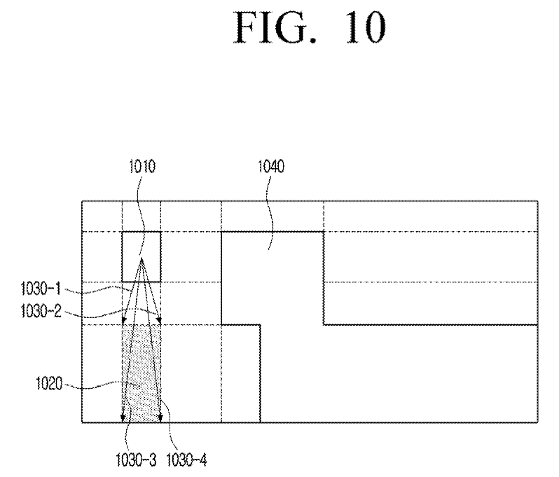

According to an embodiment, the electronic apparatus 100 may identify an area reachable by light output from the infrared sensor 240 of the external electronic apparatus 200 among the plurality of areas 810-1, 810-2, …, 810-n. In FIGS. 9 and 10 below, an operation of the electronic apparatus 100 of identifying an area reachable by light output from the external electronic apparatus 200 will be explained in detail.

FIG. 9 is a diagram for illustrating an example of an operation of an electronic apparatus of identifying an area not reachable by light among a plurality of areas according to an embodiment.

Referring to FIG. 9, the electronic apparatus 100 may identify an area not reachable by light among the plurality of areas.

According to an embodiment, the electronic apparatus 100 may identify an area not reachable by light based on whether a line connecting the first area 910 and a vertex of any one area among a plurality of areas (e.g.: the plurality of areas 810-1, 810-2, …, 810-n in FIG. 8) and the second area 940 overlap. For example, if it was identified that any one line among lines connecting a vertex of any one area among the plurality of areas and the second area 940 overlap, the electronic apparatus 100 may identify the area as an area not reachable by light. Here, the feature that a line and an area overlap may indicate a case wherein at least a part of the line is located on the area.

For example, referring to FIG. 9, the electronic apparatus 100 may identify a point located on the first area 910 and a plurality of lines 930-1, 930-2, 930-3, 930-4 connecting from the point to each vertex of the fifth area 920. As at least a part of the first line 930-1 among the plurality of lines 930-1, 930-2, 930-3, 930-4 is located on the second area 940, the electronic apparatus 100 may identify that the first line 930-1 overlaps the second area 940. In this case, the electronic apparatus 100 may identify that the fifth area 920 is an area not reachable by light. In some embodiments, the point located on the first area 910 may be a center point of the first area 910.

FIG. 10 is a diagram for illustrating an example of an operation of an electronic apparatus of identifying an area reachable by light among a plurality of areas according to an embodiment.

Referring to FIG. 10, the electronic apparatus 100 may identify an area reachable by light among a plurality of areas.

According to an embodiment, in case it was identified that a line connecting the first area 1010 and a vertex of any one area among a plurality of areas (e.g.: the plurality of areas 810-1, 810-2, …, 810-n in FIG. 8) and the second area 1040 do not overlap, the electronic apparatus 100 may identify the area as an area reachable by light.

For example, referring to FIG. 10, the electronic apparatus 100 may identify a plurality of lines 1030-1, 1030-2, 1030-3, 1030-4 connecting a point located on the first area 1010 and each vertex of the sixth area 1020. Here, as there is no line overlapped with the second area 1040 among the plurality of lines 1030-1, 1030-2, 1030-3, 1030-4, the electronic apparatus 100 may identify that the sixth area 1020 is an area reachable by light.

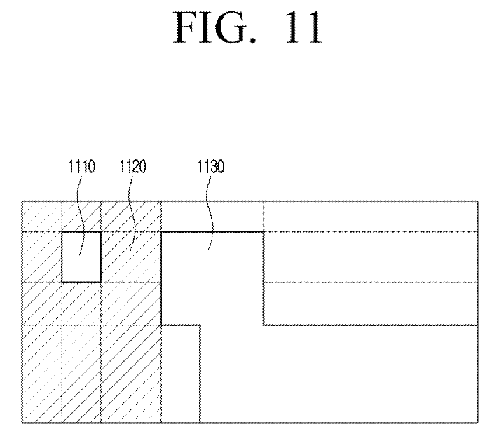

FIG. 11 is a diagram for illustrating an example of an operation of an electronic apparatus of identifying a fourth area according to an embodiment.

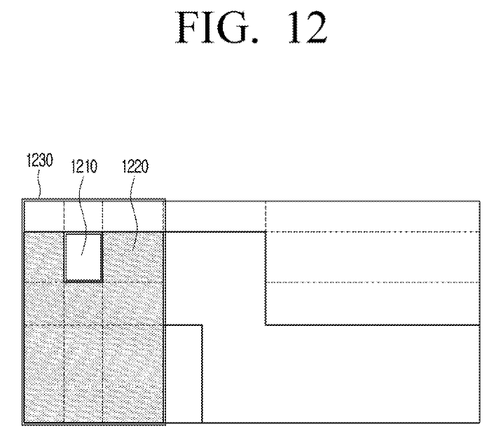

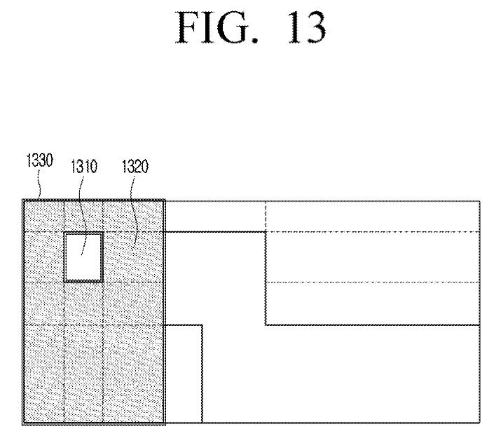

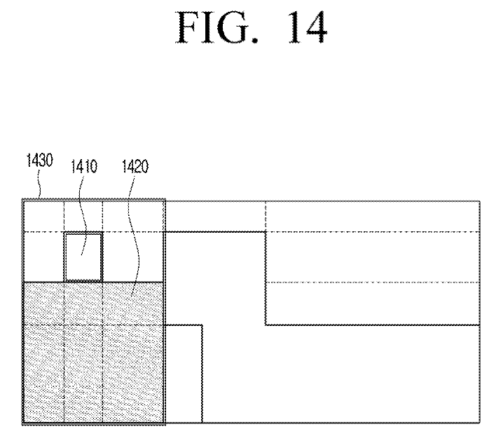

Referring to FIG. 11, the electronic apparatus 100 may identify a fourth area 1120 wherein a user input is detectable based on light output from the external electronic apparatus 200. For example, the electronic apparatus 100 may identify an area reachable by light output from the infrared sensor of the external electronic apparatus 200 (e.g.: 1020 in FIG. 10) among a plurality of areas (e.g.: the plurality of areas 810-1 to 810-n in FIG. 8). Here, the plurality of areas may include areas obtained based on extension lines of the edges of the first area 1110 and the second area 1130. The electronic apparatus 100 may obtain a fourth area 1120 consisting of areas reachable by light. According to an embodiment, the electronic apparatus 100 may project an image onto at least some areas of the fourth area. An operation of identifying at least some areas of the fourth area will be explained in FIGS. 12 to 14 below.

FIGS. 12 to 14 are diagrams illustrating an example of a candidate area according to an embodiment.

Referring to FIGS. 12 to 14, according to an embodiment, the electronic apparatus 100 may identify at least one candidate area 1220, 1320, 1420 based on an area reachable by light (1230, 1330, 1430, e.g.: the fourth area 1120 in FIG. 11) among a plurality of areas.

According to an embodiment, the electronic apparatus 100 may obtain at least one candidate area 1220, 1320, 1420 including at least one of a plurality of areas constituting the fourth area 1230, 1330, 1430. For example, the electronic apparatus 100 may identify areas constituting the candidate areas 1220, 1320, 1420 among the plurality of areas in consideration of the relation of locations with respect to the first area 1210, 1310, 1410, the sizes of the areas, and the forms of the candidate areas. As an example, the electronic apparatus 100 may first identify areas adjacent to the first area 1210, 1310, 1410. As an example, the electronic apparatus 100 may reduce the number of the areas by absorbing a relatively small area among the plurality of areas into a relatively big adjacent area. As an example, the electronic apparatus 100 may identify an area among the plurality of areas such that the forms of the candidate areas become rectangles. The electronic apparatus 100 may obtain at least one candidate area 1220, 1320, 1420 based on the identified area. Meanwhile, the candidate areas 1220, 1320, 1420 illustrated in FIGS. 12 to 14 are merely an example, and the disclosure is obviously not limited to the aforementioned example.

According to an embodiment, the electronic apparatus 100 may identify a candidate area for projecting an image among the at least one candidate areas 1220, 1320, 1420. The electronic apparatus 100 may store a first weight (e.g.: 0.8) for the size of the candidate area, a second weight (e.g.: -0.1) for the number of the edges of the candidate area, and a third weight (e.g.: -0.1) for the number of the vertices of the candidate area in the memory 120. Here, the electronic apparatus 100 may apply a positive weight to the size of the candidate area, and apply a negative weight to the number of the edges and the number of the vertices of the candidate area. However, the aforementioned weight values are merely an example, and the disclosure is obviously not limited to the aforementioned example. The weight values may be set at the time of manufacture or initial execution of the electronic apparatus 100, and may be updated from time to time or periodically through a user’s input or software update.

The electronic apparatus 100 may calculate a score by applying the weights to each of the size of the candidate area, the number of the edges of the candidate area, and the number of the vertices of the candidate area with respect to each of the at least one candidate area 1220, 1320, 1420. As an example, a case wherein the first candidate area 1220 has a first size (e.g.: 2), a first number of edges (e.g.: 8), and a first number of vertices (e.g.: 8), and the second candidate area 1320 has a second size (e.g.: 3), a second number of edges (e.g.: 8), and a second number of vertices (e.g.: 8), and the third candidate area 1420 has a third size (e.g.: 1), a third number of edges (e.g.: 4), and a third number of vertices (e.g.: 4) is assumed. The electronic apparatus 100 may identify a first score (e.g.: 0) of the first candidate area 1220, a second score (e.g.: 0.8) of the second candidate area 1320, and a third score (e.g.: 0) of the third candidate area 1420. The electronic apparatus 100 may identify a candidate area having the highest score (e.g.: the second candidate area 1320) among the at least one candidate area 1220, 1320, 1420. The electronic apparatus 100 may identify an image onto the second candidate area 1320. Meanwhile, the feature that the electronic apparatus 100 projects an image onto the second candidate area 1320 may include projecting an UI element onto the entire areas or at least some areas of the second candidate area 1320. The aforementioned values are merely an example, and the disclosure is not limited to the aforementioned example.

According to an embodiment, while controlling the projector 140 to project an image onto at least some areas of the fourth area, the electronic apparatus 100 may obtain an image by capturing a projection area by using the camera 130. The electronic apparatus 100 may identify whether the external electronic apparatus 200 or at least one object (e.g.: the at least one object 520, 530, 540 in FIG. 5) moves within the projection area based on the obtained image. For example, the electronic apparatus 100 may identify a first location of the external electronic apparatus 200 or the at least one object from an image obtained on a first time point. The electronic apparatus 100 may identify a second location of the external electronic apparatus 200 or the at least one object from an image obtained on a second time point after the first time point. The electronic apparatus 100 may identify whether the location of the external electronic apparatus 200 or the at least one object was changed by comparing the first location and the second location. For example, in case it was identified that the first location and the second location are distanced from each other by greater than or equal to a predetermined distance (e.g.: 3cm), the electronic apparatus 100 may identify that the location of the external electronic apparatus 200 or the at least one object was changed.

According to an embodiment, in case it was identified that the external electronic apparatus 200 or the at least one object moved, the electronic apparatus 100 identify an area for projecting an image again. In case the external electronic apparatus 200 or the at least one object moved, an area for projecting an image may be changed, and thus the electronic apparatus 100 may re-identify an area for projecting an image. In other words, the electronic apparatus 100 may identify a third area excluding a first area including the external electronic apparatus 200 and a second area including the at least one object. The electronic apparatus 100 may identify a fourth area, in the third area, wherein a user input is detectable based on light output from the external electronic apparatus 200. The electronic apparatus 100 may identify at least some areas of the fourth area, and project an image onto the at least some areas.

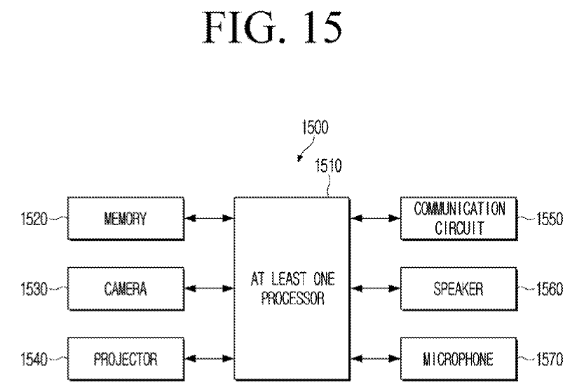

FIG. 15 is a block diagram for illustrating a detailed configuration of an electronic apparatus according to an embodiment.

The electronic apparatus 100 in FIG. 2 may correspond to the electronic apparatus 1500 in FIG. 15. Referring to FIG. 15, the electronic apparatus 1500 may include at least one of a processor 1510, memory 1520, a camera 1530, a projector 1540, a communication circuit 1550, a speaker 1560, a microphone 1570, a manipulation interface (not shown), or an input/output interface (not shown). However, these components are merely exemplary ones, and it is obvious that in carrying out the disclosure, new components may be added in addition to these components or some components may be omitted. Meanwhile, among the components illustrated in FIG. 15, regarding components that overlap with the components illustrated in FIG. 2, explanation will be omitted.

The communication circuit 1550 is a component that performs communication with various types of external electronic apparatuses according to various types of communication methods. The communication circuit 1550 may include a wireless communication module or a wired communication module. Each communication module may be implemented in a form of at least one hardware chip. The communication circuit 1550 may be referred to as a communication interface.

A wireless communication module may be a module that communicates with an external electronic apparatus wirelessly. For example, a wireless communication module may include at least one module among a Wi-Fi module, a Bluetooth module, an infrared communication module, or other communication modules.

A Wi-Fi module and a Bluetooth module perform communication by a Wi-Fi method and a Bluetooth method, respectively. In the case of using a Wi-Fi module or a Bluetooth module, various types of connection information such as a service set identifier (SSID) and a session key is transmitted and received first, and connection of communication is performed by using the information, and various types of information can be transmitted and received thereafter.

An infrared communication module performs communication according to an infrared Data Association (IrDA) technology of transmitting data to a near field wirelessly by using infrared rays between visible rays and millimeter waves.

Other communication modules may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

A wired communication module may be a module that communicates with an external electronic apparatus via wire. For example, a wired communication module may include at least one of a local area network (LAN) module, an Ethernet module, a pair cable, a coaxial cable, an optical fiber cable, or an ultra wide-band (UWB) module.

The speaker 1560 is a component that outputs audio signals. In particular, the speaker 1560 may include an audio output mixer, an audio signal processor, and an audio output module. The audio output mixer may synthesize a plurality of audio signals to be output into at least one audio signal. For example, the audio output mixer may synthesize an analog audio signal and another analog audio signal (e.g.: an analog audio signal received from the outside) into at least one analog audio signal. The audio output module may include a speaker or an output terminal. According to various embodiments, the audio output module may include a plurality of speakers, and in this case, the audio output module may be arranged inside the main body, and audio that is emitted while covering at least a portion of the diaphragm may pass through a waveguide, and may be transmitted to the outside of the main body. The audio output module may include a plurality of audio output units.

The microphone 1570 is a component for receiving input of a user voice or other sounds, and converting them into audio data. The microphone 1570 may receive a user’s voice in an activated state. For example, the microphone 1570 may be formed as an integrated type on the upper side or the front surface direction, the side surface direction, etc. of the electronic apparatus 1500. Meanwhile, the arrangement of the microphone 1570 is not limited to the aforementioned examples. The microphone 1570 may include components such as a microphone collecting a user voice in an analog form, an amp circuit amplifying the collected user voice, an A/D conversion circuit that samples the amplified user voice and converts the user voice into a digital signal, a filter circuit that removes noise components from the converted digital signal, etc. The electronic apparatus 1500 may receive a user input by using voice recognition. According to various embodiments, the electronic apparatus 1500 may receive a user input through the microphone 1570 included in the electronic apparatus 1500.

In the above, various embodiments were explained individually, but each embodiment is not necessarily implemented individually, and they may be combined on the whole or partially with at least one other embodiment and implemented together in one product.

The electronic apparatus according to the disclosure as described above may include a camera, a projector for projecting an image onto a projection area, memory storing instructions, and at least one processor including processing circuitry.

For example, the instructions, when executed by the at least one processor individually or collectively, may cause the electronic apparatus to obtain an image by capturing the projection area using the camera, identify an external electronic apparatus and at least one object within the projection area based on the obtained image, identify a third area excluding a first area including the external electronic apparatus within the projection area and a second area including the at least one object based on the obtained image, identify a fourth area, in the third area, in which a user input is detectable based on light output from the external electronic apparatus, and project an image onto at least a partial area of the fourth area using the projector.

For example, the first area may be a rectangular area including the external electronic apparatus, and the second area may include a rectangular area including each of the at least one object.

For example, the instructions, when executed by the at least one processor individually or collectively, may cause the electronic apparatus to divide the projection area into a plurality of areas based on extension lines of edges of the first area and the second area, and identify that an area to which the light output from an infrared sensor of the external electronic apparatus is reachable among the plurality of areas as the fourth area.

For example, the instructions, when executed by the at least one processor individually or collectively, may cause the electronic apparatus to, based on identifying that a line connecting the first area and a vertex of a fifth area among the plurality of areas overlaps the second area, identify the fifth area as an area that is not reachable by the light output from the infrared sensor of the external electronic apparatus, and based on identifying that a line connecting the first area and a vertex of a sixth area among the plurality of areas does not overlap the second area, identify the sixth area as an area that is reachable by the light output from the infrared sensor of the external electronic apparatus.

For example, the instructions, when executed by the at least one processor individually or collectively, may cause the electronic apparatus to identify an area that is reachable by the light among the plurality of areas, identify at least one candidate area based on the area reachable by the light, identify a candidate area among the at least one candidate area based on at least one of a size of the candidate area, a number of edges of the candidate area, or a number of vertices of the candidate area, and project the image with the identified candidate area as the at least partial area.

For example, the memory may store a weight corresponding to each of a size of a candidate area, a number of edges of a candidate area, or a number of vertices of a candidate area.

For example, the instructions, when executed by the at least one processor individually or collectively, may cause the electronic apparatus to calculate a score by applying the weight to each of the size of the candidate area, the number of edges of the candidate area, or the number of vertices of the candidate area with respect to each of the at least one candidate area, and identify a candidate area having the highest score among the at least one candidate area as the at least partial area.

For example, the electronic apparatus may further include a communication circuit.

For example, the instructions, when executed by the at least one processor individually or collectively, may cause the electronic apparatus to receive distance information between the external electronic apparatus and an external object, which is detected by the external electronic apparatus using the light, and based on identifying the user input based on the distance information, identify a touch point corresponding to the user input within the projected image based on an image obtained using the camera.

For example, the instructions, when executed by the at least one processor individually or collectively, may cause the electronic apparatus to obtain an image by capturing the projection area using the camera while controlling the projector to project an image onto at least a partial area of the fourth area, and based on identifying that the external electronic apparatus or the at least one object has moved within the projection area based on the obtained image, identify the at least partial area of the fourth area.

A controlling method of an electronic apparatus according to the disclosure may include obtaining an image by capturing the projection area using a camera, and identifying an external electronic apparatus and at least one object within the projection area based on the obtained image, identifying a third area excluding a first area including the external electronic apparatus within the projection area and a second area including the at least one object based on the obtained image, identifying a fourth area, in the third area, in which a user input is detectable based on light output from the external electronic apparatus, and projecting an image onto at least a partial area of the fourth area using the projector.

For example, the first area may be a rectangular area including the external electronic apparatus, and the second area may include a rectangular area including each of the at least one object.

For example, identifying the fourth area may include the steps of dividing the projection area into a plurality of areas based on extension lines of edges of the first area and the second area, and identifying that an area to which the light output from an infrared sensor of the external electronic apparatus is reachable among the plurality of areas as the fourth area.

For example, identifying the fourth area may include the steps of, based on identifying that a line connecting the first area and a vertex of a fifth area among the plurality of areas overlaps the second area, identifying the fifth area as an area that is not reachable by the light output from the infrared sensor of the external electronic apparatus, and based on identifying that a line connecting the first area and a vertex of a sixth area among the plurality of areas does not overlap the second area, identifying the sixth area as an area that is reachable by the light output from the infrared sensor of the external electronic apparatus.

For example, projecting an image onto the at least partial area of the fourth area may include the steps of identifying at least one area constituting the fourth area among the plurality of areas, identifying at least one candidate area based on the at least one area, identifying a candidate area among the at least one candidate area based on at least one of a size of the candidate area, a number of edges of the candidate area, or a number of vertices of the candidate area, and projecting the image with the identified candidate area as the at least some areas.

For example, the step of projecting an image onto the at least partial area of the fourth area may include the steps of calculating a score by applying a weight to each of the size of the candidate area, the number of edges of the candidate area, or the number of vertices of the candidate area with respect to each of the at least one candidate area, and identifying a candidate area having the highest score among the at least one candidate area as the at least partial area.

For example, the controlling method may further include receiving distance information between the external electronic apparatus and an external object, which is detected by the external electronic apparatus using the light, and based on identifying the user input based on the distance information, identifying a touch point corresponding to the user input within the projected image based on an image obtained using the camera.

For example, the controlling method may further include obtaining an image by capturing the projection area using the camera while controlling the projector to project an image onto at least a partial area of the fourth area, and based on identifying that the external electronic apparatus or the at least one object has moved within the projection area based on the obtained image, identifying at least a partial area of the fourth area.

In a non-transitory computer-readable recording medium storing instructions which, when executed by at least one processor of an electronic apparatus, cause the electronic apparatus perform operations, the operations may include the steps of obtaining an image by capturing the projection area using a camera, and identifying an external electronic apparatus and at least one object within the projection area based on the obtained image, identifying a third area excluding a first area including the external electronic apparatus within the projection area and a second area including the at least one object based on the obtained image, identifying a fourth area, in the third area, in which a user input is detectable based on light output from the external electronic apparatus, and projecting an image onto at least a partial area of the fourth area using the projector.

Meanwhile, the embodiments of the disclosure may also be implemented in a form of a recording medium including instructions executable by a computer such as a program module executed by a computer. A computer-readable medium may be any available medium accessible by a computer, and includes all of a volatile medium and a non-volatile medium, and a separable medium and a non-separable medium. Also, a computer-readable medium may include a computer storage medium and a communication medium. A computer storage medium includes all of a volatile medium and a non-volatile medium, and a separable medium and a non-separable medium implemented by any methods or technologies for storing information such as computer-readable instructions, data structures, program modules, or various types of data. A communication medium may typically include various types of data of modulated data signals such as computer-readable instructions, data structures, or program modules.

Also, a storage medium that is readable by a computer may be provided in the form of a non-transitory storage medium. Here, the term ‘a non-transitory storage medium’ only means that the storage medium is a tangible device, and does not include a signal (e.g.: an electromagnetic wave), and the term does not distinguish a case wherein data is stored semi-permanently in a storage medium and a case wherein data is stored temporarily. For example, ‘a non-transitory storage medium’ may include a buffer wherein data is temporarily stored.

According to an embodiment, the method according to the various embodiments disclosed herein may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line (e.g.: download or upload) through an application store or directly between two user devices (e.g.: smartphones). In the case of on-line distribution, at least a portion of a computer program product (e.g.: a downloadable app) may be stored in a storage medium such as the server of the manufacturer, the server of the application store, and the memory of the relay server at least temporarily, or may be generated temporarily.

Also, the description of the disclosure described above is merely exemplary, and a person having ordinary knowledge in the technical field to which the disclosure belongs would be able to understand that the disclosure can be easily modified into other specific forms while the technical idea or essential features of the disclosure are not changed. Therefore, the embodiments described above are exemplary ones in all aspects, and are intended to be understood as not being restrictive. For example, each component described as a single type may also be implemented while being dispersed. Likewise, components described to be dispersed may also be implemented in a combined form.

Further, the scope of the disclosure is expressed by the appended claims rather than by the detailed description above, and it intended to be interpreted that all changed or modified forms derived from the meaning and the scope of the claims and an equivalent concept thereof are included in the scope of the disclosure.

What is claimed is:

1. An electronic apparatus comprising:
a camera;
a projector configured to project an image onto a projection area;
memory storing instructions; and
at least one processor including processing circuitry,
wherein the instructions, when executed by the at least one processor individually or collectively, cause the electronic apparatus to:
obtain an image of the projection area captured by the camera;
identify an external electronic apparatus and at least one object within the projection area based on the image;
identify, within the projection area, a first area including the external electronic apparatus and a second area including the at least one object based on the obtained image;
identity a third area of the projection area excluding the first area and the second area;
identify a fourth area, in the third area, in which a user input is detectable based on light output from the external electronic apparatus; and
project, via the projector, a projection image onto at least a partial area of the fourth area.

2. The electronic apparatus as claimed in claim 1,
wherein the first area is a rectangular area including the external electronic apparatus, and
wherein the second area includes a rectangular area including each of the at least one object.

3. The electronic apparatus as claimed in claim 2, wherein the instructions, when executed by the at least one processor individually or collectively, cause the electronic apparatus to:
divide the projection area into a plurality of areas based on extension lines of edges of the first area and the second area, and
identify, as the fourth area, an area to which the light output from an infrared sensor of the external electronic apparatus is reachable among the plurality of areas.

4. The electronic apparatus as claimed in claim 3, wherein the instructions, when executed by the at least one processor individually or collectively, cause the electronic apparatus to:
based on identifying that a line connecting the first area and a vertex of a fifth area among the plurality of areas overlaps the second area, identify the fifth area as an area that is not reachable by the light output from the infrared sensor of the external electronic apparatus, and
based on identifying that the line connecting the first area and the vertex of the fifth area among the plurality of areas does not overlap the second area, identify the fifth area as an area that is reachable by the light output from the infrared sensor of the external electronic apparatus.

5. The electronic apparatus as claimed in claim 2, wherein the instructions, when executed by the at least one processor individually or collectively, cause the electronic apparatus to:
divide the projection area into a plurality of areas based on extension lines of edges of the first area and the second area;
identify an area that is reachable by the light among the plurality of areas,
identify one or more candidate areas based on the area reachable by the light,
identify a candidate area among the one or more candidate areas based on at least one of a size of the candidate area, a number of edges of the candidate area, or a number of vertices of the candidate area, and
project the projection image with the identified candidate area as the at least partial area.

6. The electronic apparatus as claimed in claim 5,
wherein the memory stores a weight corresponding to each of the size of a candidate area, the number of edges of a candidate area, or the number of vertices of a candidate area, and
wherein the instructions, when executed by the at least one processor individually or collectively, cause the electronic apparatus to:
calculate a score by applying the weight to each of the size of the candidate area, the number of edges of the candidate area, or the number of vertices of the candidate area with respect to each of the one or more candidate areas, and
identify the candidate area having the highest score among the one or more candidate areas as the at least partial area.

7. The electronic apparatus as claimed in claim 1, further comprising:
a communication circuit,
wherein the instructions, when executed by the at least one processor individually or collectively, cause the electronic apparatus to:
receive distance information between the external electronic apparatus and an external object detected by the external electronic apparatus using the light through the communication circuit, and
based on identifying the user input based on the distance information, identify a touch point corresponding to the user input within the projection image based on the image obtained using the camera.

8. The electronic apparatus as claimed in claim 1,
wherein the instructions, when executed by the at least one processor individually or collectively, cause the electronic apparatus to:
obtain the image of the projection area captured by the camera while controlling the projector to project the projection image onto the at least partial area of the fourth area; and
based on identifying that the external electronic apparatus or the at least one object has moved within the projection area based on the image, re-identify the fourth area.

9. A controlling method of an electronic apparatus comprising a projector for projecting an image onto a projection area, the method comprising:
obtaining an image of the projection area captured by a camera, and identifying an external electronic apparatus and at least one object within the projection area based on the image;
identifying, within the projection area, a first area including the external electronic apparatus and a second area including the at least one object based on the image;
identifying a third area of the projection area excluding the first area and the second area;
identifying a fourth area, in the third area, in which a user input is detectable based on light output from the external electronic apparatus; and
projecting, via the projector, a projection image onto at least a partial area of the fourth area.

10. The controlling method as claimed in claim 9,
wherein the first area is a rectangular area including the external electronic apparatus, and
wherein the second area includes a rectangular area including each of the at least one object.

11. The controlling method as claimed in claim 10,
wherein the identifying the fourth area comprises:
dividing the projection area into a plurality of areas based on extension lines of edges of the first area and the second area; and
identifying, as the fourth area, an area to which the light output from an infrared sensor of the external electronic apparatus is reachable among the plurality of areas.

12. The controlling method as claimed in claim 11,
wherein the identifying the fourth area further comprises:
based on identifying that a line connecting the first area and a vertex of a fifth area among the plurality of areas overlaps the second area, identifying the fifth area as an area that is not reachable by the light output from the infrared sensor of the external electronic apparatus; and
based on identifying that the line connecting the first area and the vertex of the fifth area among the plurality of areas does not overlap the second area, identifying the fifth area as an area that is reachable by the light output from the infrared sensor of the external electronic apparatus.

13. The controlling method as claimed in claim 11,
wherein the projecting the projection image onto the at least partial area of the fourth area comprises:
identifying at least one area constituting the fourth area among the plurality of areas;
identifying one or more candidate areas based on the at least one area constituting the fourth area;
identifying a candidate area among the one or more candidate areas based on at least one of a size of the candidate area, a number of edges of the candidate area, or a number of vertices of the candidate area; and
projecting the projection image with the identified candidate area as the at least partial area.

14. The controlling method as claimed in claim 13,
wherein the projecting the projection image onto the at least partial area of the fourth area comprises:
calculating a score by applying a weight to each of the size of the candidate area, the number of edges of the candidate area, or the number of vertices of the candidate area with respect to each of the one or more candidate areas; and
identifying the candidate area having the highest score among the one or more candidate areas as the at least partial area.

15. A non-transitory computer-readable recording medium storing instructions which, when executed by at least one processor of an electronic apparatus comprising a projector for projecting an image onto a projection area, cause the electronic apparatus perform operations,
wherein the operations comprise:
obtaining an image of the projection area captured by a camera, and identifying an external electronic apparatus and at least one object within the projection area based on the image;
identifying, within the projection area, a first area including the external electronic apparatus and a second area including the at least one object based on the image;
identifying a third area of the projection area excluding the first area and the second area;
identifying a fourth area, in the third area, in which a user input is detectable based on light output from the external electronic apparatus; and
projecting, via the projector, a projection image onto at least a partial area of the fourth area.

16. The electronic apparatus as claimed in claim 1, wherein the third area is a remainder of the projection area excluding the first area and the second area.

17. The electronic apparatus as claimed in claim 7, wherein the instructions, when executed by the at least one processor individually or collectively, cause the electronic apparatus to:
identify the user input based on the distance information indicating that a distance between the external electronic apparatus and the external object is less than or equal to a predetermined distance.
